(19) United States
(12) Patent Application Publication
(10) Pub. No.: US 2026/0075386 A1
(43) Pub. Date: Mar. 12, 2026

(54) SENSING ARCHITECTURE AND PROCEDURE IN 3GPP-BASED CELLULAR NETWORKS

(71) Applicant: Telefonaktiebolaget LM Ericsson (publ), Stockholm (SE)

(72) Inventors: Ritesh Shreevastav, Upplands Väsby (SE); Julia Equi, Helsinki (FI); Gabor Fodor, Hässelby (SE); Iana Siomina, Täby (SE)

(21) Appl. No.: 19/106,672

(22) PCT Filed: Aug. 31, 2023
(86) PCT No.: PCT/IB2023/058632

§ 371 Date: Feb. 26, 2025

Related U.S. Application Data
(60) Provisional application No. 63/403,516, filed on Sep. 2, 2022.

(51) Int. Cl. H04W 4/029; G01S 13/46

(52) U.S. Cl. CPC H04W 4/029; G01S 13/46

(57) ABSTRACT

In various embodiments disclosed herein, a method and architecture for a Sensing Management Function (SeMF) is provided to enable the network to perform sensing and localization to provide accurate positioning while also efficiently using network resources. The SeMF can configure sensing nodes (e.g., base stations, Transmission Reception Points (TRPs) and User Equipment devices (UEs)) to perform sensing, and based on the sensing data and other information, send a trigger to a Location Management Function (LMF) to initiate localization. Likewise, the LMF can perform localization, and based on the location data, or Quality of Service (QOS) requirements, also send a trigger to the SeMF to initiate sensing. Additionally, disclosed is a method for configuring the sensing nodes to perform sensing.

### RELATED APPLICATIONS

This application claims the benefit of provisional patent application Ser. No. 63/403,516, filed Sep. 2, 2022, the disclosure of which is hereby incorporated herein by reference in its entirety.

### TECHNICAL FIELD

The present disclosure relates to the method for a sensing procedure and a sensing architecture in a wireless communication system.

### BACKGROUND

### Sensing

Recently, the system architectures (SA1 and SA2) groups of the 3rd Generation Partnership Project (3GPP) have received a proposal (3GPP S2-2106022 New SID: 5G Architecture Enhancements for Harmonized Communications and Sensing Services, August 2021) to identify use cases and architectural enhancements that will enable Joint Communications and Sensing (JCAS) in cellular networks. Sensing using cellular networks can be performed in a monostatic setting when transmitter and receiver sensing antennas are located in the same node and in a multi-static setting when the transmitter and receiver sensing antennas are located in different nodes.

In FIGS. 1A, 1B, and 1C different radar settings are depicted that can be deployed using cellular base stations. The goal is to detect and localize a target 104 which is, in general, a non-connected to the network object (such as a pedestrian, an animal, etc.). In FIG. 1A, the monostatic setting refers to the setting, for which the transmit sensing antenna array 102, denoted by transmission-s (TX-s), is co-located at the same node (here, the same base station) as the receiver sensing antenna array 102, denoted by reception-s (RX-s). In FIG. 1B, the bi-static setting corresponds to the case where the transmit sensing array antennas TX-s 106 is located at a different node as compared to the receiver sensing antennas RX-s 108. Finally, in FIG. 1C, multi-static case is depicted for which several TX-s 110 and 114 and several RX-s 112 and 116 are present and they are all located at different nodes (base stations here).

The monostatic radar case, for which the base station uses Fifth Generation (5G) mm Wave signals for sensing was considered in Barneto et al. where estimation of range and velocity resolutions and self-interference analysis are performed. Target localization using bi-static and multi-static radar with 5G New Radio (NR) wave-form was studied, using 5G based on measurements of time difference of arrival and angle of arrival with 5G NR waveforms.

### Positioning

The NR Positioning architecture is described below and in FIG. 2. The Location Management Function (LMF) 212 is the location node in NR. There are also interactions between the LMF 212 and the gNodeB (gNB) 208 or eNodeB (eNB) 206 in the Radio Access Network (RAN) 202 via the NR Positioning Protocol a (NRPPa) protocol and the Accessibility and Mobility Management Function (AMF) 210. The interactions between the gNodeB 208 and the device (e.g., User Equipment (UE)) 204 is supported via the Radio Resource Control (RRC) protocol. An Enhanced Serving Mobile Location Center (E-SMLC) 214 is a network element that resides in the Base Station Controller (BSC) and calculates network-based location of mobile devices such as UE 204.

DL-TDOA: The downlink (DL) Time Difference of Arrival (TDOA) positioning method makes use of the DL Ref. Signal Time Difference (RSTD) (and optionally DL Positioning Reference Signal (PRS) Reference Signal Received Power (RSRP)) of downlink signals received from multiple Transmission Points (TPs), at the UE 204. The UE 204 measures the DL RSTD (and optionally DL PRS RSRP) of the received signals using assistance data received from the positioning server, and the resulting measurements are used along with other configuration information to locate the UE 204 in relation to the neighboring TPs.

Multi-RTT: The Multi-Round Trip Time (RTT) positioning method makes use of the UE Rx-Tx measurements and DL PRS RSRP of downlink signals received from multiple Transmission Reception Points (TRPs), measured by the UE 204 and the measured gNB Rx-Tx measurements and uplink (UL) Sounding Reference Signal (SRS) RSRP at multiple TRPs of uplink signals transmitted from UE 204.

UL-TDOA: The UL TDOA positioning method makes use of the UL TDOA (and optionally UL SRS-RSRP) at multiple RPs of uplink signals transmitted from UE 204. The RPs measure the UL TDOA (and optionally UL SRS-RSRP) of the received signals using assistance data received from the positioning server, and the resulting measurements are used along with other configuration information to estimate the location of the UE 204.

DL-AoD: The DL Angle of Departure (AoD) positioning method makes use of the measured DL PRS RSRP of downlink signals received from multiple TPs, at the UE 204. The UE 204 measures the DL PRS RSRP of the received signals using assistance data received from the positioning server, and the resulting measurements are used along with other configuration information to locate the UE 204 in relation to the neighboring TPs.

UL-AoA: The UL Angle of Arrival (AoA) positioning method makes use of the measured azimuth and zenith of arrival at multiple RPs of uplink signals transmitted from the UE 204. The RPs measure A-AoA and Z-AoA of the received signals using assistance data received from the positioning server, and the resulting measurements are used along with other configuration information to estimate the location of the UE 204.

NR-ECID: NR Enhanced Cell ID (NR E CID) positioning refers to techniques which use additional UE measurements available at the UE 204 and/or NR radio resource and other measurements to improve the UE location estimate.

### Sensor Based Positioning

3GPP Release-15 introduced support for the motion-sensor positioning method. The UE 204 can provide movement information. This movement information comprises displacement results estimated as an ordered series of points. The motion-sensor based positioning method was introduced such that it can be combined with other positioning methods i.e., to create hybrid positioning methods. When combined/fused with the Assisted Global Navigation Satellite System (A-GNSS) based positioning method, the UE 204 can be located using relative positioning, which is especially useful when the UE 204 loses the Global Positioning System (GPS) connection in a tunnel. Thus, instead of absolute positioning, the UE 204 can be tracked based upon displacement results. The motion-sensor results can also be combined with the DL-TDOA positioning method, such that the estimated positioning computation result can be compensated based upon the information on the factor of UE 204 movement during the measurements.

### SUMMARY

In various embodiments disclosed herein, a method and architecture for a Sensing Management Function (SeMF) is provided to enable the network to perform sensing and localization to provide accurate positioning of a target object. The sensing and localization may occur during different time periods or during at least partially overlapping time periods. In certain embodiments, the SeMF may enable the network to switch or alternate between sensing and localization to provide accurate positioning while also efficiently using network resources. The SeMF can configure sensing nodes (e.g., base stations, Transmission Reception Points (TRPs) and User Equipment devices (UE)) to perform sensing, and based on the sensing data and other information, send a trigger to a Location Management Function (LMF) to initiate localization. Likewise, the LMF can perform localization, and based on the location data, or Quality of Service (QOS) requirements, also send a trigger to the SeMF to initiate sensing. Additionally, disclosed is a method for configuring the sensing nodes to perform sensing.

In an embodiment, a method performed by the SeMF for initiating localization (e.g., positioning or tracking) by a LMF can include receiving, from a network node, a first trigger to initiate sensing of a target object. The method can also include facilitating performance of the sensing of the target object by a base station, resulting in sensing data. The method can also include based on the sensing data, determining that localization of the target object is to be performed. The method can also include providing to the LMF a second trigger to initiate localization of the target object.

In an embodiment, a network node implementing an SeMF can include a memory that stores computer executable instructions and a processor that executes the computer-executable instructions to perform operations, including receiving, from a network node, a first trigger to initiate sensing of a target object. The operations can also include facilitating performance of the sensing of the target object by a base station, resulting in sensing data. The operations can also include based on the sensing data, determining that localization of the target object is to be performed. The operations can also include providing to the LMF a second trigger to initiate localization of the target object.

In an embodiment, a method performed by a LMF for initiating sensing by a SeMF can include receiving a first trigger to initiate localization of a target object. The method can also include facilitating performance of the localization of the target object, resulting in localization data and based on one or more of the localization data or a QoS requirement associated with first trigger, determining that sensing of the target object is to be performed. The method can include providing to the SeMF a second trigger to initiate sensing of the target object.

In an embodiment, a network node implementing an LMF can include a memory that stores computer executable instructions and a processor that executes the computer-executable instructions to perform operations, including receiving a first trigger to initiate localization of a target object. The operations can also include facilitating performance of the localization of the target object, resulting in localization data and based on one or more of the localization data or a QoS requirement associated with first trigger, determining that sensing of the target object is to be performed. The operations can include providing to the SeMF a second trigger to initiate sensing of the target object.

In an embodiment, a method performed by the SeMF for initiating sensing of a target object can include receiving, from a network node a first trigger to initiate sensing of the target object. The method can also include determining one or more sensing nodes to perform the sensing. The method can also include determining one or more sensing parameters for the one or more sensing nodes to use to perform the sensing. The method can also include configuring the one or more sensing nodes to perform the sensing based on the sensing parameters. The method can also include receiving sensing data from the one or more sensing nodes and performing, by the SeMF, a network operation based on the sensing data.

In an embodiment, a network node implementing an SeMF can include a memory that stores computer executable instructions and a processor that executes the computer-executable instructions to perform operations, including receiving, from a network node a first trigger to initiate sensing of the target object. The operations can also include determining one or more sensing nodes to perform the sensing. The operations can also include determining one or more sensing parameters for the one or more sensing nodes to use to perform the sensing. The operations can also include configuring the one or more sensing nodes to perform the sensing based on the sensing parameters. The operations can also include receiving sensing data from the one or more sensing nodes and performing, by the SeMF, a network operation based on the sensing data.

In the present disclosure an architecture for sensing is provided, which can potentially be supported by Third Generation Partnership Project (3GPP), and is based upon enhancements of the current 3GPP architecture.

Sensing can be complex in terms of processing requirements, in which both communication and sensing signals must be transmitted and processed. Therefore, it should only be enabled when needed/triggered to save network (NW), energy, and spectrum resources.

Sensing and localization (positioning or tracking) can work in tandem such that when low complexity/processing is desired, the system can fall back from sensing to localization and when precise localization is needed, then sensing can be (re-)activated, and at times both can be activated.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A-1C depict different radar settings that can be deployed using cellular base stations according to one or more embodiments of the present disclosure;

FIG. 2 is a block diagram illustration of New Radio (NR) Positioning architecture according to one or more embodiments of the present disclosure;

FIG. 3 is an illustration depicting the Sensing Management Function (SeMF) entity is in the Third Generation Partnership Project (3GPP) Radio Access Network (RAN) architecture according to one or more embodiments of the present disclosure;

FIG. 4 is an illustration depicting the SeMF entity is in the 3GPP core architecture according to one or more embodiments of the present disclosure;

FIGS. 5A and 5B illustrate how the SeMF can be triggered or invoked by various network nodes according to one or more embodiments of the present disclosure;

FIG. 6 illustrates an exemplary embodiment of an SeMF receiving sensing data according to one or more embodiments of the present disclosure;

FIG. 7 is a table depicting sensing classification parameters according to one or more embodiments of the present disclosure;

FIG. 8 illustrates a method performed by a SeMF for initiating localization (e.g., positioning or tracking) by a Location Management Function (LMF) according to one or more embodiments of the present disclosure;

FIG. 9 illustrates a method performed by an LMF for initiating sensing by a SeMF according to one or more embodiments of the present disclosure;

FIG. 10 illustrates a method performed by a SeMF for initiating sensing of a target object according to one or more embodiments of the present disclosure;

FIG. 11 illustrates one example of a cellular communications system in which embodiments of the present disclosure may be implemented according to one or more embodiments of the present disclosure;

FIG. 12 illustrates a wireless communication system represented as a Fifth Generation (5G) network architecture according to one or more embodiments of the present disclosure;

FIG. 13 illustrates a 5G network architecture using service-based interfaces according to one or more embodiments of the present disclosure;

FIG. 14 is a schematic block diagram of a radio access node according to some embodiments of the present disclosure;

FIG. 15 is a schematic block diagram that illustrates a virtualized embodiment of the radio access node according to some embodiments of the present disclosure;

FIG. 16 is a schematic block diagram of the radio access node according to some other embodiments of the present disclosure;

FIG. 17 is a schematic block diagram of a wireless communication device according to some embodiments of the present disclosure; and

FIG. 18 is a schematic block diagram of the wireless communication device according to some other embodiments of the present disclosure.

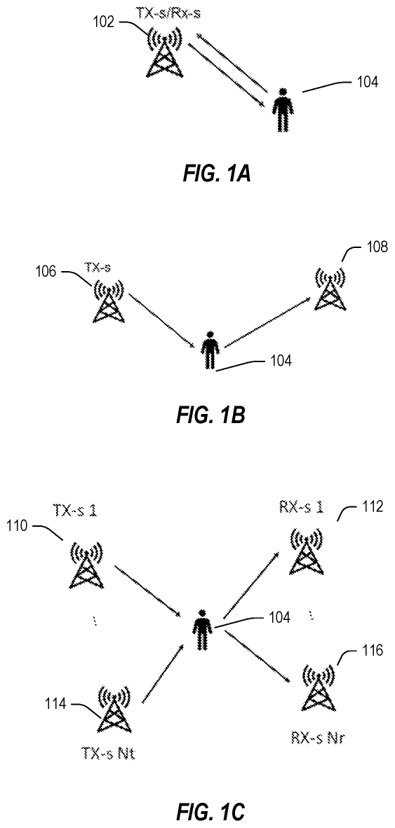

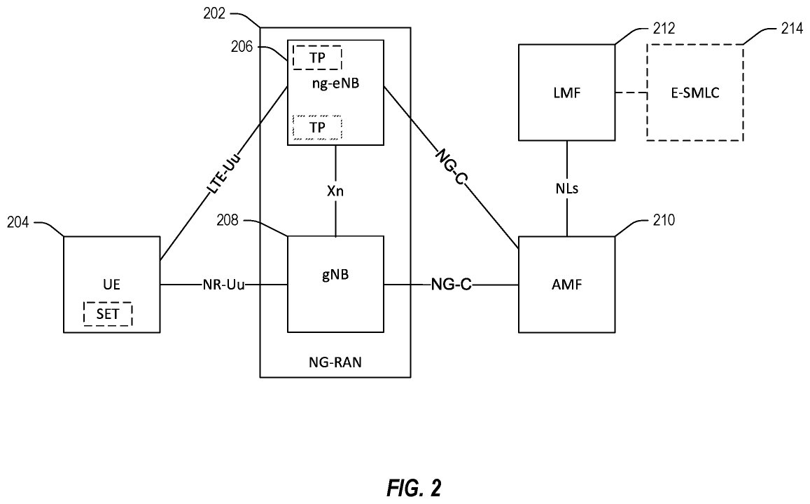

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

SEMF: Sensing Management function (SeMF) is a specific node or a logical node or a functional block in a node which can be part of the Core Network or part of edge computing (that is located closer to User Equipment (UE) such as located along side or within radio base stations). The SeMF manages the UE context for sensing purposes. It configures the participating base stations and UE to perform sensing and obtains the results from the base station and UE. The UE context for SeMF consists of UE ID and the output of sensing, sensing data or sensing result.

Sensing Output/sensing Data/sensing Result: Can Be Based Upon the Below Values associated with the sensed object according to the present disclosure:
An RF (radio-frequency) or IR (infra-red) measurement characteristic, e.g.:
   Timing measurement (e.g., Round trip time, Time of Arrival (TOA), Reception-Transmission (rx-tx) time difference, etc.) of the signal (time when signal was sent+time when the reflected signal was received by the sender);
   Radio signal strength, radio signal quality, Signal to Interference plus Noise Ratio (SINR), etc. ;
   Phase measurement;
   Multipath characteristics;
   Power delay profile;
   Delay spread;
   Doppler spectra;
   Doppler spread;
   Doppler shift;
   Doppler frequency; and
   Velocity, Angle of arrival, angle of departure;
Environmental measurement characteristic, e.g., temperature, pressure, etc. ;
One or more parameters comprising or indicative of the shape of the sensed object;
Recognition data or recognition result (e.g., from object recognition or image recognition);
Location or estimated distance of the sensed object; and
A parameter indicative of the estimated quality or the target quality of the sensing output/data/result, e.g., estimated or target quality of any of the value above. Some examples of such parameter: confidence level (e.g., 90%), uncertainty, estimated range of possible values, maximum deviation, standard deviation, variance, accuracy, resolution, sampling rate, delay, averaging time, number of samples, observation period, observation time interval, sensitivity level, etc.

The above values may comprise a measurement sample, a single value (absolute or relative), a series, a statistical value based on more than one sample (e.g., an average, median, a value associated with a certain percentile, a filtered value, etc.), a parameter derived from a measurement result, or a function describing inter-dependency of one or more measurement parameters based on the measurement results.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a UE in a 3GPP network, a Machine Type Communication (MTC) device, and an Internet of Things (IOT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/reception Point (trp): in Some Embodiments, a Trp May Be Either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one PRS-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenges. There is currently no architecture defined for sensing in 3GPP. Specifically, the problem is the following:
Which 3GPP entities should be involved and/or specified for monostatic, bistatic and multistatic radar techniques such that interoperability is maintained and the 3GPP network can perform sensing with sufficient accuracy?
What procedures and protocols should be executed by the 3GPP sensing entities for the mono, bi and multistatic cases, such that these sensing mechanisms are interoperable.

Certain aspects of the present disclosure and their embodiments may provide solutions to the aforementioned or other challenges.

In the present disclosure an architecture for sensing is provided, which can potentially be supported by 3GPP, and is based upon enhancements of the current 3GPP architecture.

Sensing can be complex in terms of processing requirements, in which both communication and sensing signals must be transmitted and processed. Therefore, it should only be enabled when needed/triggered to save network (NW), energy, and spectrum resources.

Sensing and localization (positioning or tracking) can work in tandem such that when low complexity/processing is desired, the system can fall back from sensing to localization and when precise localization is needed, then sensing can be (re-)activated, and at times both can be activated.

To this end, an architecture and procedure are defined as to how sensing and localization (positioning or tracking) co-exist together, and the behavioral description is provided.

As such there may not be infinite radio resources for sensing, i.e., sensing resources (time, frequency, spatial beams, sensing antennas, sensing transmitter/receiver denoted here by TX-s and RX-s, respectively) are limited and there is a need to efficiently choose sensing parameters in order to detect/localize a large number of targets. The present disclosure also describes how the number of TX-s and RX-s can be selected.

The present disclosure provides a new entity called a Sensing Management Function (SeMF). A procedure is defined, whereby it is possible for the sensing SeMF to invoke the location management function (LMF) and similarly, for LMF to invoke SeMF. A further procedure is defined on how SeMF selects the gNB for sensing purposes and how the results are aggregated and computed. Additionally, uplink (UL) and downlink (DL) sensing configuration and procedures are described.

Certain embodiments may provide one or more of the following technical advantage(s). The present disclosure elaborates the details of the procedures for sensing services. In particular, it provides the architecture and procedure to enable the sensing and localization (positioning or tracking) functions to work in tandem or together. A SeMF is defined which is invoked on-demand. Specifically, in the monostatic case, as sensing requires full duplex operation, the sensing may consume large resources (dedicated beams for sensing) and may be computational heavy. In order to simplify, the SeMF can be invoked on-demand only when needed, for example, when the LMF-based localization does not meet application requirements.

In various embodiments disclosed herein, a method and architecture for a SeMF is provided to enable the network to perform sensing and localization. In certain embodiments, the SeMF may enable the network to switch or alternate between sensing and localization to provide accurate positioning while also efficiently using network resources. The SeMF can configure sensing nodes (e.g., base stations, TRPs and UEs) to perform sensing, and based on the sensing data and other information, send a trigger to a LMF to initiate localization. Likewise, the LMF can perform localization, and based on the location data, or Quality of Service (QOS) requirements, also send a trigger to the SeMF to initiate sensing. Additionally, disclosed is a method for configuring the sensing nodes to perform sensing.

According to the present disclosure, Sensing and Positioning/Localization are defined as two distinct entities in the proposed architecture, which interwork to perform efficient sensing if the object location is known, and similarly from the sensing results the proposed architecture can extract the location and/or the parameters needed for Positioning/Localization.

Tracking is another component associated with Positioning. Once absolute position is determined, then relative positioning can be performed to track the user. According to the present disclosure, for sensing, tracking enables the system to keep track of the object in order to continue performing sensing, e.g., if the object is stationary or mobile. If it is mobile, the system determines at what speed the UE is moving; so that sensing system can be (re)configured accordingly, e.g., antennas or beams can be oriented correctly. The system can incorporate current positioning methods specified by the 3GPP, which support tracking by means of sensor-based positioning (e.g., using inertia measurement units (IMU)-based, displacement tracking).

Positioning may be associated with a requirement, such as a requirement to determine the position of a UE according to a certain QoS (e.g., based on any of accuracy, latency, confidence, uncertainty). For positioning, the requirement may originate from location clients. An example of a Positioning client (Location Services Client (LCS)) can be an application running on the UE side, such as a navigation application. The application sets the QoS requirement for positioning, for example, based on the needs of the application with respect to delay and accuracy. Another example of an LCS client can be lawful interception. Thus, an external client may request the location server to provide the user position. It is important to realize that as sensing and positioning impose different requirements/techniques, the 5GC architecture for sensing may need to satisfy specific sensing requirements imposed by specific applications such as sensing clients.

Advanced 5G will enable new use cases; for example, a traffic monitoring system (for smart city). The traffic monitoring system can request the location server to provide the number and types of vehicles at a traffic junction. In such a scenario, localization may be inefficient as it may be difficult to keep track of several thousand vehicles in a city. Also, the existing LMF is designed to localize the connected vehicles, while sensing can localize and determine other characteristics about vehicles that are not connected to the RAN.

According to the present disclosure, sensing comes as an aid. Once sensing is performed (including passive, non-connected vehicles), a more accurate positioning procedure is triggered. For example, at a traffic junction, if there is a speed limit, and if any car breaks that, the sensing procedure can detect and trigger localization (e.g., positioning and/or tracking) for such user. The sensing node through image/radar processing will detect the registration number and provide the number to the traffic monitoring system. In case of a connected vehicle, the traffic monitoring system may then obtain the vehicle-embedded sim card information and establish a connection to perform positioning and tracking of such vehicles.

Similarly, on the device side (e.g., a car), there can be a sensing client (application), which senses the environment to understand if there is any obstacle ahead.

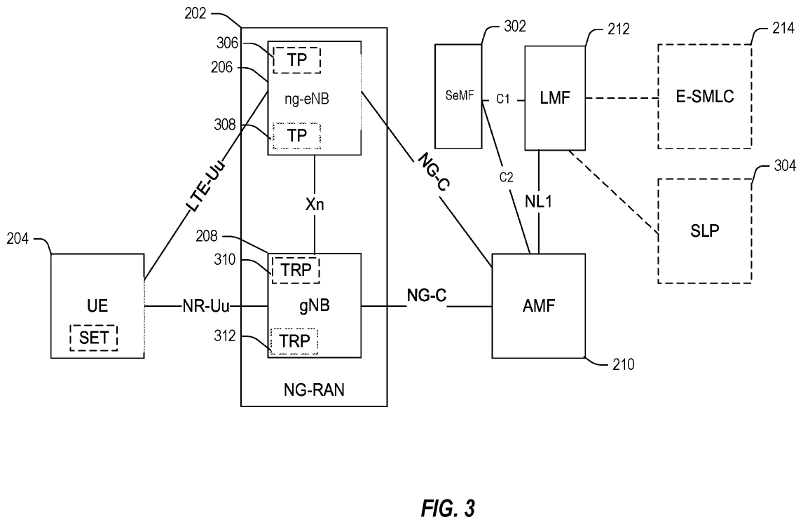

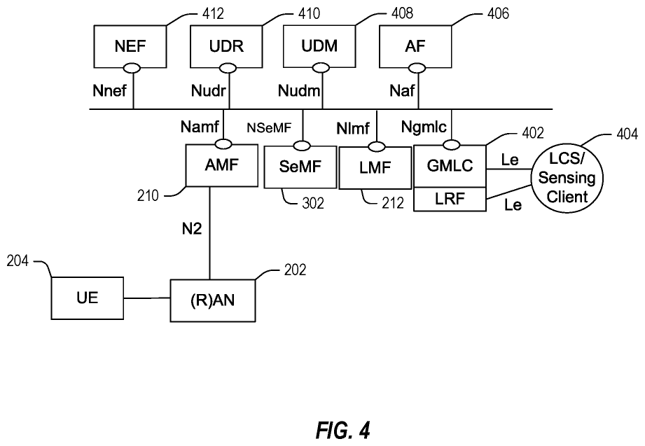

FIG. 3 depicts how the SeMF entity is included in the 3GPP RAN architecture according to one or more embodiments of the present disclosure. The SeMF 302 can interface via C1 towards the LMF 212 and via C2 towards the AMF 210 which facilitates communications with the gNB 208 or eNB 206 via the radio access network node's TRPs 306, 308, 310, and 312 with the UE 204. Each of the UE 204, eNB 206, and gNB 310 can be used as sensing nodes by the SeMF 302 to facilitate sensing of one or more target objects.

FIG. 4 depicts how the SeMF 302 is included in the 3GPP core network architecture. In addition to the AMF 210, the SeMF 302, LMF 212, and RAN 202, the core network can also include a Network Exposure Function (NEF) 412, Unified Data Repository (UDR) 410, Unified Data Manager (UDM) 408, Application Function (AF) 406, and Gateway Mobile Location Center (GMLC) 402 and a Location Services (LCS)/Sensing Client 404.

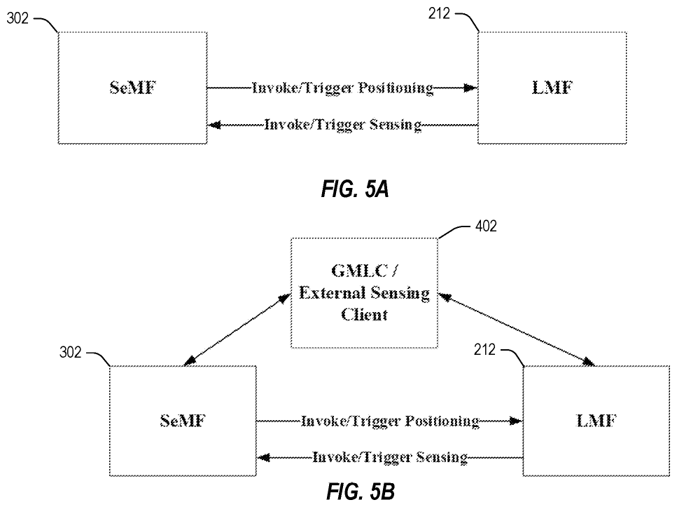

FIGS. 5A and 5B illustrate different embodiments of SeMF 302 and LMF 212 interactions.

At least sensing invoking/triggering is implemented in the system, but there may also be positioning invoking/triggering; furthermore, if both implemented in a system, the order of triggering sensing and positioning may be different in different systems, e.g., sensing first or positioning first. Sensing invoking/triggering may comprise, e.g., a command to perform the corresponding action, triggering parameter such as triggering condition, triggering periodicity, triggering delay, triggering time/schedule, etc. The invoking/triggering may also be followed by the response to the triggering action, e.g., after receiving an invoking/triggering sensing request from a network entity, the SeMF 302 may send a response to that entity.

There may also be sensing configuration and/or assistance data provided to the SeMF 302, e.g., from another network entity which may be LMF, AMF, Serving Mobile Location Center (SMLC), a radio network node, etc. The sensing configuration and/or assistance data may be provided to SeMF 302 together with sensing invoking/triggering message or in a separate message or even upon a request for sensing configuration and/or assistance data sent from SeMF 302. In some examples, sensing assistance data may also comprise positioning data or may be generated based on positioning data.

Sensing configuration and/or assistance data may comprise at least one configuration parameter for sensing, e.g.: related to sensing quality, sensing periodicity, sensing result structure, sensing time, radio frequency and/or bandwidth configuration for sensing at which sensing is to be performed, radio signal types or configuration of one or more radio signals based on which sensing is to be performed, etc.

SeMF 302 may also create and provide sensing configuration and/or assistance data to sensing nodes, which perform sensing or control the nodes performing sensing. The sensing configuration and/or assistance data may be created based on the sensing nodes capability (its ability to support certain one or a set of sensing operations or sensing parameter configurations), which the sensing node may indicate to SeMF 302.

A sensing node configures its sensing operation based on the received sensing configuration and/or assistance data. A sensing node may send the sensing data or sensing results upon a request, a trigger or periodically. Such sensing nodes may comprise a radio network node (e.g., 206, 208) or UE 204, which may further comprise SeMF 302. The sensing operation may comprise one or more of: transmitting radio signals for sensing, receiving radio signals to obtain sensing output/sensing data/sensing result, obtaining at least one parameter value characterizing sensing output/sensing data/sensing result, configuring one or more radio antenna parameter for sensing, configuring sensing beams or antenna direction for sensing, etc.

SeMF may also receive one or more sensing data or sensing results from one or more sensing nodes. Upon receiving sensing results, the SeMF may further send some or all sensing results to another network node (e.g., LMF 212, AMF 210, E-SMLC 214, etc.).

As shown in FIG. 5A, the SeMF 302 can invoke or trigger positioning or localization by the LMF 212 and the LMF 212 can also invoke or trigger sensing by the SeMF 302. In some embodiments, the order in which the sensing or localization is performed or invoked can vary, with one or the other being performed first.

As shown in FIG. 5B, in some embodiments the GMLC or external client 402 can initiate either sensing by the SeMF 302 or localization by the LMF 212, and depending on either the sensing data or the location data, and one or more QoS requirements or requirements of the GMLC or external client 402, the SeMF 302 can trigger the LMF 212 to perform localization or the LMF 212 can trigger the SeMF 302 to perform sensing.

The location estimate output is characterized by:
(x, y, z) co-ordinates,
the uncertainty associated with the estimates,
confidence level

The sensing output or sensing data/result is as defined above in the terminology description; few are provided again below as an example:
Round trip time of the reflected/backscattered signal (time when signal was sent+time when the signal was received by the sender)
Doppler frequency,
Velocity,
Angle of arrival, angle of departure,
Shape,
Image recognition,
Target size, range

The architecture and procedures described above support, among others, the following use cases, which serve as examples.

In some use cases, sensing may be initiated first, and depending upon the need to further localize and track the UE 204; the sensing management function triggers a positioning request to LMF 212 either directly or via an external node such as GMLC with involvement of AMF 210 for routing information.

In some other use cases, especially related to precise localization/positioning/tracking some input from sensing may also be required. In such cases, the LMF may invoke/trigger a sensing procedure by requesting the sensing management function. Upon receiving such a request, SeMF 302 will involve the necessary TRPs/gNBs to perform sensing for that and provide the necessary configuration. The gNBs would obtain the measurement and provide it to SeMF 302 which in turn would provide it to LMF 212 for precise location estimation.

As sensing may use full duplex operation, consume large resources (dedicated beams for sensing) and is potentially computational heavy; the SeMF 302 can be invoked on-demand only when needed. For example, when the positioning accuracy is not satisfactory for a specific application, or when the application explicitly requests triggering the sensing-enhancement as a service.

In some embodiments, the SeMF 302 and LMF 212 can be co-located to reduce any latency as a result of the communications between the SeMF 302 and LMF 212.

Some of the method performed by the SeMF 302 include:
Obtain trigger for sensing from external entity via AF 406 connected to NEF 412;
Perform Sensing; and
Determine the need for localization (tracking or positioning, e.g., based on an estimate of longitude, latitude computation->x, y, z co-ordinates) and thus trigger request towards LMF 212.

Methods performed by the LMF 212 include:
Obtain trigger for positioning from external entity such as GMLC 402 via AF 406 connected to NEF 412;
Perform Positioning Procedure;
Determine the need for sensing (for e.g., need for precise positioning); and
Invoke the sensing request to SeMF 302.

Other methods performed by the SeMF 302:
Receive request from LMF 212 for sensing or from external source;
Identify the gNBs that should be involved for sensing based upon:
   Filter gNBs based upon proximity from the device to be sensed i.e., initial input from LMF 212 on coarse location of the device to be sensed;
   A serving cell;
   gNBs (e.g., 208) capability on sensing such as monostatic, bi-static, or multi-static sensing capabilities; and
   considering interference;
Configure the necessary sensing configuration on such identified gNB (the configuration can also be pre-configured and activated based upon an index); and
Obtain the result from the multiple gNBs/TRPs and evaluate the result and compute a final sensing output:
   A differential result can be performed from multiple TRPs to further sense the object from different gNBs perspective; and
   Different weights can be assigned to different TRPs/gNBs result based upon the confidence of the measurement (provided by each gNBs) or based upon the proximity of each gNBs with the object.

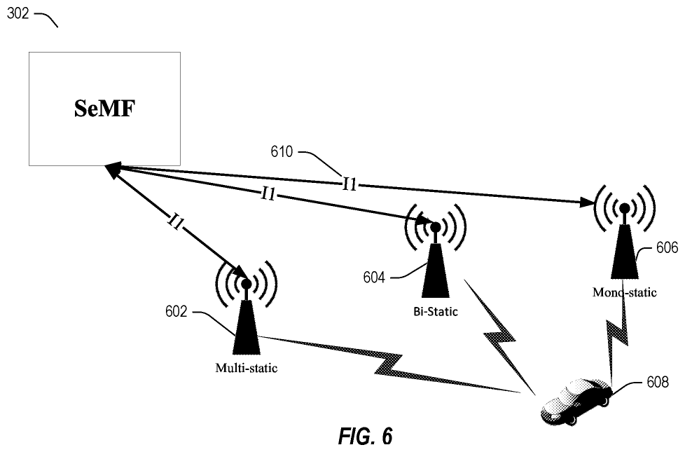

FIG. 6 illustrates an exemplary embodiment of a SeMF 302 receiving sensing data and aggregating sensing data from a plurality of different sensor nodes, including sensor nodes that are multi-static (602), bi-static (604), and mono-static (606) that are each performing sensing of target object 608. 11 610 is a new interface between SeMF 302 and gNBs 208.

For positioning, the gNB measures Time of arrival, gNB Rx-Tx or UL-AoA and based upon that the LMF 212 computes the position. However, for sensing, the aggregation and result analysis and evaluation, according to the invention, may be different.

One of the main differences between DL positioning and DL sensing is that a passive device is not involved, i.e., sensing can be UE agnostic. This also implies that there is no common Tx originating from a device (e.g., UL-SRS). Each gNB has its own Tx and/or Rx, depending on the sensing setting (monostatic, bi-static, or multi-static). However, SeMF 302 may identify a gNB whose sensing beam transmission can be defined as common Tx. SeMF 302 would then request other gNBs capable of either bi-static or multi-static to listen to that Tx.

In an embodiment, the SeMF 302 defines a common Tx from a gNB (which can be termed reference gNB for sensing). SeMF 302 may appoint the reference gNB based upon on the target location (and eventually direction). All other neighbor gNBs are then informed to listen to the reception and perform the computation and report to the SeMF 302.

Each gNB (e.g., gNB 208) measures, e.g.:
a) Round trip time of the reflected signal (time when signal was sent+time when the signal was received by the sender)
b) Doppler frequency,
c) Velocity,
d) Angle of arrival, angle of departure,
e) Shape/size
f) Image recognition
g) Movement direction

It can so happen that each gNB is able to perform a partial recognition of the shape or object identification. SeMF 302 would then have to aggregate the result and make a collage to draw a conclusion on the object identification.

In some other embodiment, the SeMF 302 chooses the set of TX and RX for sensing based on the scenario/use case. For example, in safety critical scenarios, the number of sensing RX should be larger as compared to some other scenario such as traffic monitoring.

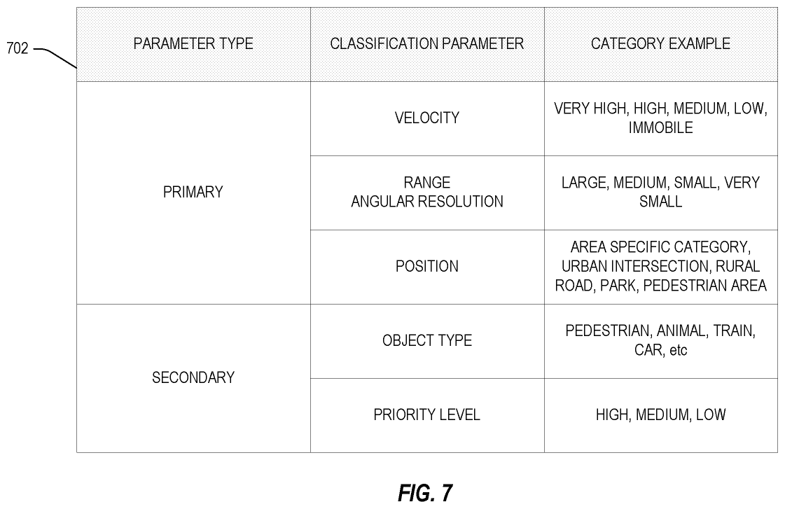

In some other embodiment, the SeMF 302 chooses the set of TX and RX for sensing based on some parameters such as classifying the sensing either primary or secondary based upon different characteristics such as shown in the table 702 in FIG. 7 which provides sensing classification parameters and different category examples.

The two main types of target sensing parameters are primary and secondary.

Primary classification parameters: parameters depending on the physical characteristics of the target such as target's speed, position, material, size.

Other primary parameters can be used depending on available additional sensing tools or intelligent surfaces (IRS): temperature, material, heart rate, etc.

Secondary classification parameters: parameters that depend on the target's environment/area, scenario or use such as priority level.

Depending upon the classification and associated characteristics, the SeMF 302 may decide the set of TX and RX for sensing.

In some other embodiment, the SeMF 302 chooses the set of TX and RX for sensing based on the sensing area or position of the sensed targets.

In another embodiment, the UE 204 signals to the gNB 208 that it has sensing capability and supports NAS or Sensing protocol procedures on top of NAS to get configuration data from the SeMF. This enables the SeMF 302 to choose bi-static sensing and configure the UE 204 to act as a sensor (e.g.: to perform DL sensing measurements for any object). The sensing beam from any gNB 208 may reflect to the object and captured by the UE 204 as sensor. Further, SeMF 302 can configure the UE 204 to transmit UL signals for sensing which can be measured by other nodes (gNBs/TRPs or even other UEs).

In another embodiment, the LMF notifies the SeMF 302 that in a specific location, sensing is necessary due to low signal to noise ratio (SNR) values of the radio signals necessary for localization.

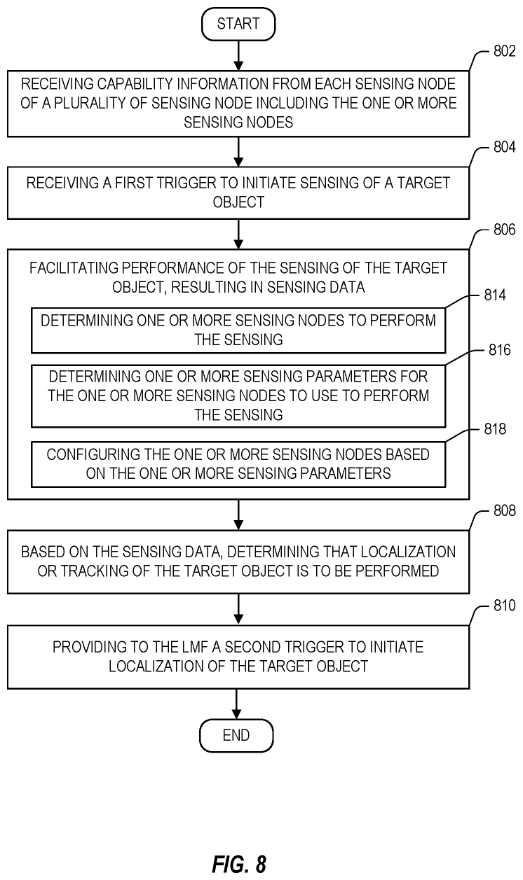

FIG. 8 illustrates a method performed by a SeMF for initiating localization (e.g., positioning or tracking) by an LMF.

The method in FIG. 8 starts at step 802, where the method includes receiving capability information from each sensing node of a plurality of sensing nodes including the one or more sensing nodes. The capabilities can include whether the sensing nodes can operate in one or more of monostatic, bi-static, or multi-static sensing modes, as well as the physical capabilities (e.g., frequencies, powers, types etc.) of the sensing nodes.

At step 804, the method includes receiving a first trigger to initiate sensing of a target object. The first trigger to initiate sensing can be received from the LMF 212, or from a client device/system 404 or GMLC 402.

At step 806, the method includes facilitating performance of the sensing of the target object, resulting in sensing data.

At step 814, the facilitating performance of the sensing can further include determining one or more sensing nodes to perform the sensing. The one or more sensing nodes can be selected based on:
Filter gNBs based upon proximity from the device to be sensed i.e., initial input from LMF on coarse location of the device to be sensed;
Serving cell;
gNBs capability on sensing such as monostatic, bi-static, or multi-static sensing capabilities; and
considering interference.

At step 816, the facilitating performance of the sensing can further include determining one or more sensing parameters for the one or more sensing nodes to use to perform the sensing. The one or more sensing parameters can include:
sensing quality;
sensing periodicity;
sensing result structure;
sensing time;
radio frequency and/or bandwidth configuration for sensing at which sensing is to be performed; and
radio signal types or configuration of one or more radio signals based on which sensing is to be performed, etc.

At step 818, the facilitating performance of the sensing can further include configuring the one or more sensing nodes based on the one or more sensing parameters.

At step 808, the method includes based on the sensing data, determining that localization (e.g., positioning or tracking) of the target object is to be performed. The localization can be determined to be necessary in response to determining that the target object is a UE 204 or associated with a UE and can thus be localized by the system, and also whether the target object is moving and needs to be tracked.

At step 810, the method includes providing to the LMF 212 a second trigger to initiate localization of the target object.

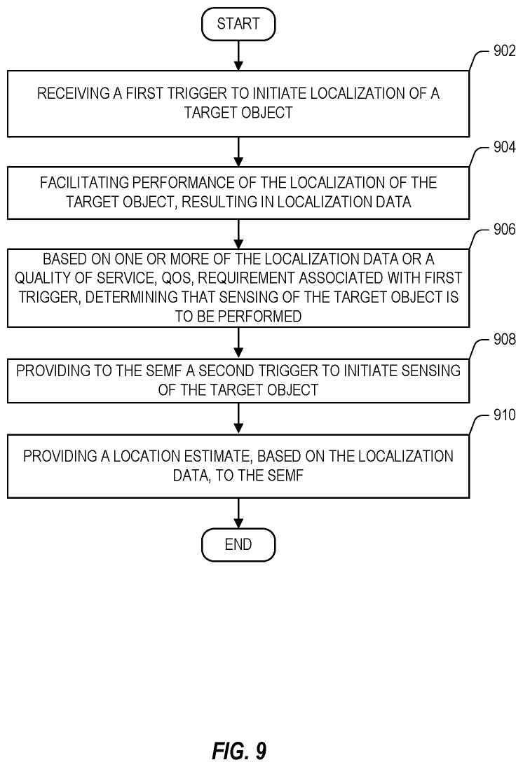

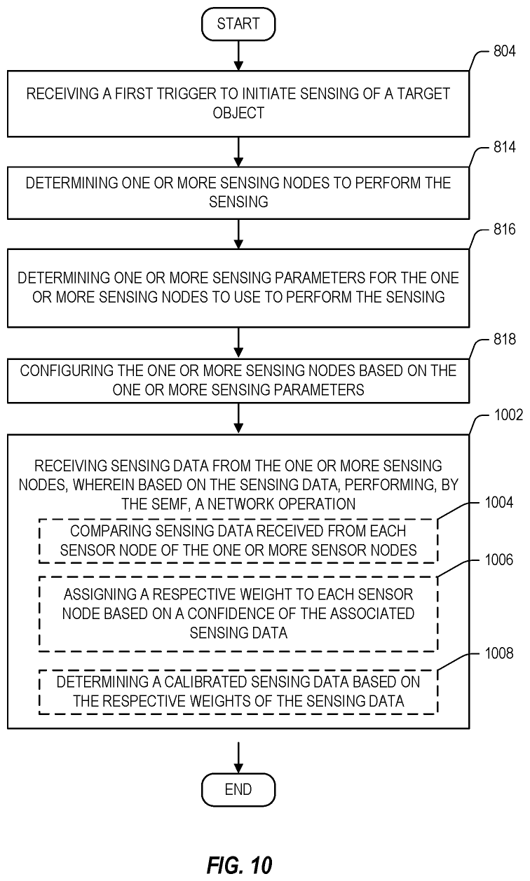

FIG. 9 illustrates a method performed by an LMF 212 for initiating sensing by a SeMF 302.

The method can begin at step 902 which includes receiving a first trigger to initiate localization (e.g., positioning or tracking) of a target object. The localization can be determined to be necessary in response to determining that the target object is a UE 204 or associated with a UE and can thus be localized by the system, and also whether the target object is moving and needs to be tracked.

At step 904, the method includes facilitating performance of the localization of the target object, resulting in localization data. Localization data can include absolute location, as well as relative location to the TRPs and or absolute or relative velocity/acceleration of the target object.

At step 906, the method includes based on one or more of the localization data or a QoS requirement associated with first trigger, determining that sensing of the target object is to be performed. As an example, a QoS requirement may indicate that a position of a UE should be determined according to a certain QoS (e.g., based on any of accuracy, latency, confidence, uncertainty). For positioning, the requirement may originate from location clients. An example of a Positioning client (Location services client; LCS) can be an application running on the UE side, such as a navigation app. The app sets the requirement for QoS for positioning as in what should be the delay and accuracy need, for example.

At step 908, the method includes providing to the SeMF a second trigger to initiate sensing of the target object. The sensing configuration and/or assistance data may be provided to SeMF 302 together with sensing invoking/triggering message or in a separate message or even upon a request for sensing configuration and/or assistance data sent from SeMF 302.

At step 910, the method includes providing a location estimate, based on the localization data, to the SeMF. In some examples, sensing assistance data may also comprise positioning data or may be generated based on positioning data.

FIG. 10 illustrates a method performed by a SeMF 302 for initiating sensing of a target object. The method can include steps 804, 814, 816, and 818 from FIG. 8, and then include new step 1002 of receiving sensing data from the one or more sensing nodes, wherein based on the sensing data, the performing, by the SeMF, a network operation.

Included in the receiving sensor data 1002 are optional steps 1004, 1006, and 1008, where step 1004 includes comparing sensing data received from each sensor node of the one or more sensor nodes. Sensing data can include data related to:
Timing measurement (e.g., round trip time, TOA, rx-tx time difference, etc.) of the signal (time when signal was sent+time when the reflected signal was received by the sender)
Radio signal strength, radio signal quality, SINR, etc.
Phase measurement
Multipath characteristics
Power delay profile
Delay spread
Doppler spectra
Doppler spread
Doppler shift,
Doppler frequency,
Velocity, Angle of arrival, angle of departure,
Environmental measurement characteristic, e.g., temperature, pressure, etc.
One or more parameters comprising or indicative of the shape of the sensed object
Recognition data or recognition result (e.g., from object recognition or image recognition)
Location or estimated distance of the sensed object
A parameter indicative of the estimated quality or the target quality of the sensing output/data/result, e.g., estimated or target quality of any of the value above. Some examples of such parameter: confidence level (e.g., 90%), uncertainty, estimated range of possible values, maximum deviation, standard deviation, variance, accuracy, resolution, sampling rate, delay, averaging time, number of samples, observation period, observation time interval, sensitivity level, etc.

Step 1006 includes assigning a respective weight to each sensor node based on a confidence of the associated sensing data. Different weights can be assigned to different TRPs/gNBs result based upon the confidence of the measurement (provided by each gNBs) or based upon the proximity of each gNBs with the object.

Step 1008 includes determining a calibrated sensing data based on the respective weights of the sensing data.

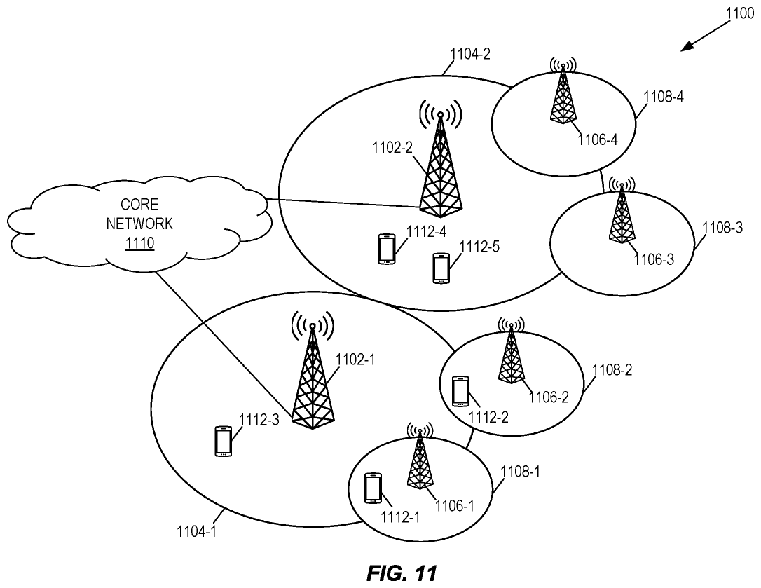

FIG. 11 illustrates one example of a cellular communications system 1100 in which embodiments of the present disclosure may be implemented. In the embodiments described herein, the cellular communications system 1100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 1102-1 and 1102-2, which in the 5GS include NR base stations (gNBs) and optionally next generation eNBs (ng-eNBs) (e.g., LTE RAN nodes connected to the 5GC) and in the EPS include eNBs controlling corresponding (macro) cells 1104-1 and 1104-2. The base stations 1102-1 and 1102-2 are generally referred to herein collectively as base stations 1102 and individually as base station 1102. Likewise, the (macro) cells 1104-1 and 1104-2 are generally referred to herein collectively as (macro) cells 1104 and individually as (macro) cell 1104. The RAN may also include a number of low power nodes 1106-1 through 1106-4 controlling corresponding small cells 1108-1 through 1108-4. The low power nodes 1106-1 through 1106-4 can be small base stations (such as pico or femto base stations) or RRHs, or the like. Notably, while not illustrated, one or more of the small cells 1108-1 through 1108-4 may alternatively be provided by the base stations 1102. The low power nodes 1106-1 through 1106-4 are generally referred to herein collectively as low power nodes 1106 and individually as low power node 1106. Likewise, the small cells 1108-1 through 1108-4 are generally referred to herein collectively as small cells 1108 and individually as small cell 1108. The cellular communications system 1100 also includes a core network 1110, which in the 5GS is referred to as the 5GC. The base stations 1102 (and optionally the low power nodes 1106) are connected to the core network 1110.

The base stations 1102 and the low power nodes 1106 provide service to wireless communication devices 1112-1 through 1112-5 in the corresponding cells 1104 and 1108. The wireless communication devices 1112-1 through 1112-5 are generally referred to herein collectively as wireless communication devices 1112 and individually as wireless communication device 1112. In the following description, the wireless communication devices 1112 are oftentimes UEs, but the present disclosure is not limited thereto.

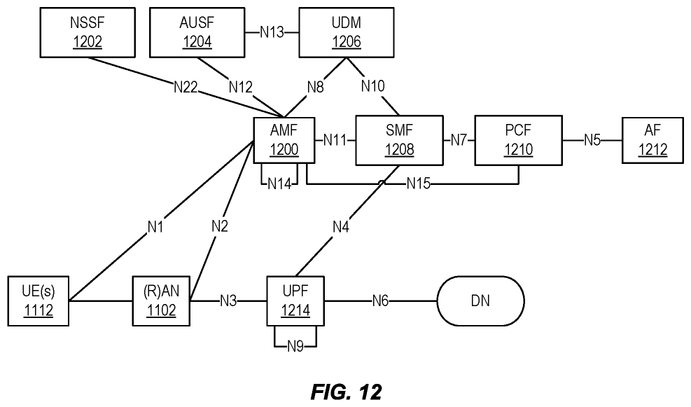

FIG. 12 illustrates a wireless communication system represented as a 5G network architecture composed of core Network Functions (NFs), where interaction between any two NFs is represented by a point-to-point reference point/interface. FIG. 12 can be viewed as one particular implementation of the system 1100 of FIG. 11.

Seen from the access side the 5G network architecture shown in FIG. 12 comprises a plurality of UEs 1112 connected to either a RAN 1102 or an Access Network (AN) as well as an AMF 1200. Typically, the R(AN) 1102 comprises base stations, e.g., such as eNBs or gNBs or similar. Seen from the core network side, the 5GC NFs shown in FIG. 12 include a NSSF 1202, an AUSF 1204, a UDM 1206, the AMF 1200, a SMF 1208, a PCF 1210, and an Application Function (AF) 1212.

Reference point representations of the 5G network architecture are used to develop detailed call flows in the normative standardization. The N1 reference point is defined to carry signaling between the UE 1112 and AMF 1200. The reference points for connecting between the AN 1102 and AMF 1200 and between the AN 1102 and UPF 1214 are defined as N2 and N3, respectively. There is a reference point, N11, between the AMF 1200 and SMF 1208, which implies that the SMF 1208 is at least partly controlled by the AMF 1200. N4 is used by the SMF 1208 and UPF 1214 so that the UPF 1214 can be set using the control signal generated by the SMF 1208, and the UPF 1214 can report its state to the SMF 1208. N9 is the reference point for the connection between different UPFs 1214, and N14 is the reference point connecting between different AMFs 1200, respectively. N15 and N7 are defined since the PCF 1210 applies policy to the AMF 1200 and SMF 1208, respectively. N12 is required for the AMF 1200 to perform authentication of the UE 1112. N8 and N10 are defined because the subscription data of the UE 1112 is required for the AMF 1200 and SMF 1208.

The 5GC network aims at separating UP and CP. The UP carries user traffic while the CP carries signaling in the network. In FIG. 12, the UPF 1214 is in the UP and all other NFs, i.e., the AMF 1200, SMF 1208, PCF 1210, AF 1212, NSSF 1202, AUSF 1204, and UDM 1206, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 1200 and SMF 1208 are independent functions in the CP. Separated AMF 1200 and SMF 1208 allow independent evolution and scaling. Other CP functions like the PCF 1210 and AUSF 1204 can be separated as shown in FIG. 12. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

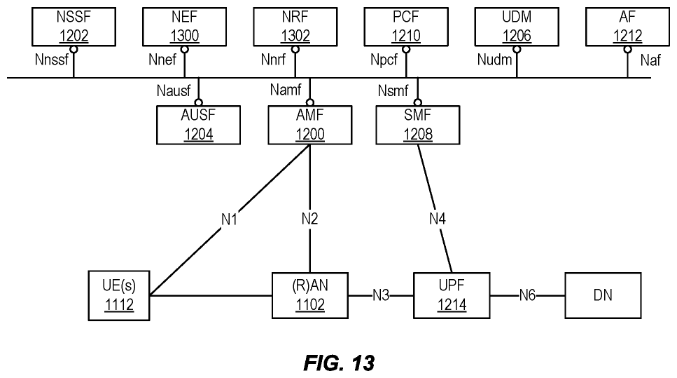

FIG. 13 illustrates a 5G network architecture using service-based interfaces between the NFs in the CP, instead of the point-to-point reference points/interfaces used in the 5G network architecture of FIG. 12. However, the NFs described above with reference to FIG. 12 correspond to the NFs shown in FIG. 13. The service(s) etc. that a NF provides to other authorized NFs can be exposed to the authorized NFs through the service-based interface. In FIG. 13 the service based interfaces are indicated by the letter “N” followed by the name of the NF, e.g., Namf for the service based interface of the AMF 1200 and Nsmf for the service based interface of the SMF 1208, etc. The NEF 1300 and the NRF 1302 in FIG. 13 are not shown in FIG. 12 discussed above. However, it should be clarified that all NFs depicted in FIG. 12 can interact with the NEF 1300 and the NRF 1302 of FIG. 13 as necessary, though not explicitly indicated in FIG. 12.

Some properties of the NFs shown in FIGS. 12 and 13 may be described in the following manner. The AMF 1200 provides UE-based authentication, authorization, mobility management, etc. A UE 1112 even using multiple access technologies is basically connected to a single AMF 1200 because the AMF 1200 is independent of the access technologies. The SMF 1208 is responsible for session management and allocates Internet Protocol (IP) addresses to UEs. It also selects and controls the UPF 1214 for data transfer. If a UE 1112 has multiple sessions, different SMFs 1208 may be allocated to each session to manage them individually and possibly provide different functionalities per session. The AF 1212 provides information on the packet flow to the PCF 1210 responsible for policy control in order to support QoS. Based on the information, the PCF 1210 determines policies about mobility and session management to make the AMF 1200 and SMF 1208 operate properly. The AUSF 1204 supports authentication function for UEs or similar and thus stores data for authentication of UEs or similar while the UDM 1206 stores subscription data of the UE 1112. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

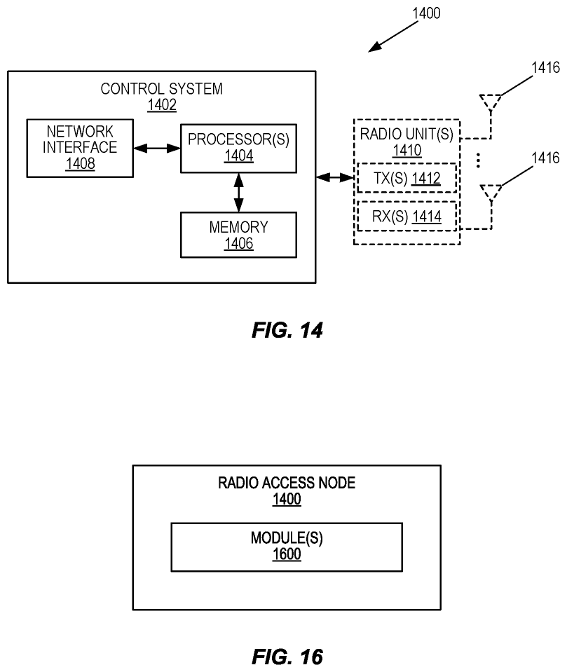

FIG. 14 is a schematic block diagram of a radio access node 1400 according to some embodiments of the present disclosure. Optional features are represented by dashed boxes. The radio access node 1400 may be, for example, a base station 1102 or 1106 or a network node that implements all or part of the functionality of the base station 1102 or gNB described herein. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICs, FPGAs, and/or the like), memory 1506, and a network interface 1508.

In this example, functions 1510 of the radio access node 1400 described herein are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

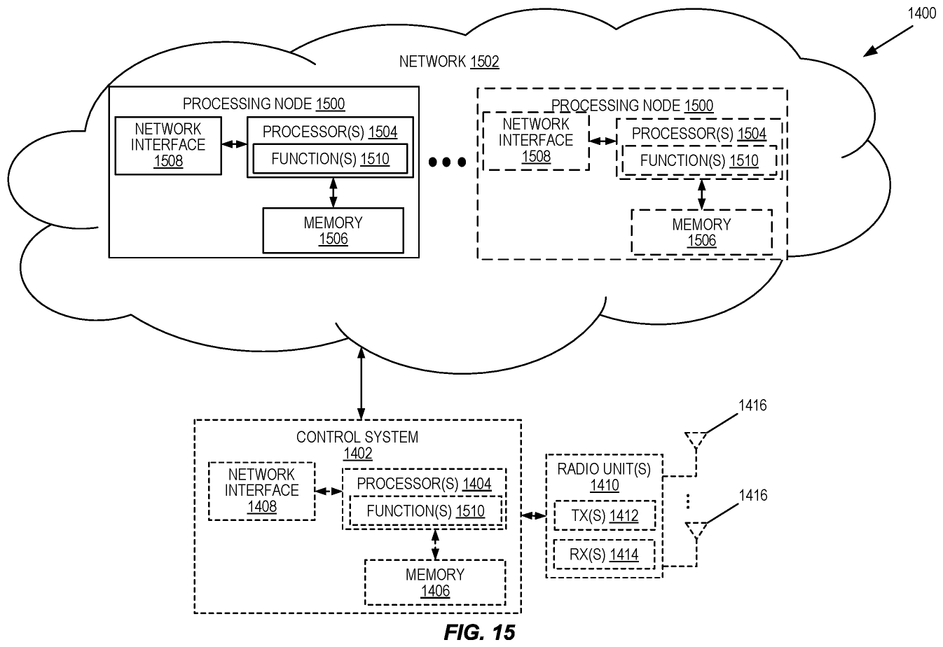

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

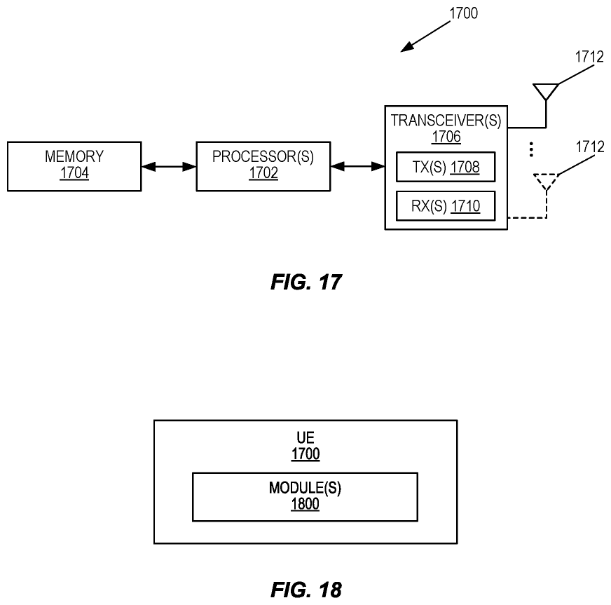

FIG. 17 is a schematic block diagram of a wireless communication device 1700 according to some embodiments of the present disclosure. As illustrated, the wireless communication device 1700 includes one or more processors 1702 (e.g., CPUs, ASICs, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the wireless communication device 1700 described above may be fully or partially implemented in software that is, e.g., stored in the memory 1704 and executed by the processor(s) 1702. Note that the wireless communication device 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the wireless communication device 1700 and/or allowing output of information from the wireless communication device 1700), a power supply (e.g., a battery and associated power circuitry), etc.

In some embodiments, a computer program including instructions which, when executed by at least one processor, causes the at least one processor to carry out the functionality of the wireless communication device 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the wireless communication device 1700 according to some other embodiments of the present disclosure. The wireless communication device 1700 includes one or more modules 1800, each of which is implemented in software. The module(s) 1800 provide the functionality of the wireless communication device 1700 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Embodiment 1. A method performed by a Sensing Management Function, SeMF, for initiating localization (e.g., positioning or tracking) by a Location Management Function, LMF, the method comprising: receiving a first trigger to initiate sensing of a target object; facilitating performance of the sensing of the target object, resulting in sensing data; based on the sensing data, determining that localization of the target object is to be performed; and providing to the LMF a second trigger to initiate localization of the target object.

Embodiment 2. The method of embodiment 1, wherein the facilitating performance of the sensing of the target object further comprises: determining one or more sensing nodes to perform the sensing; and determining one or more sensing parameters for the one or more sensing nodes to use to perform the sensing; and configuring the one or more sensing nodes based on the one or more sensing parameters.

Embodiment 3. The method of embodiment 2, wherein the one or more sensing parameters comprise at least one parameter related to: sensing quality; sensing periodicity; sensing result structure; sensing time; radio frequency and/or bandwidth configuration for sensing at which sensing is to be performed; and radio signal types or configuration of one or more radio signals based on which sensing is to be performed, etc.

Embodiment 4. The method of any of embodiments 2-3, wherein prior to determining the one or more sensing nodes and one or more sensing parameters, the method further comprises receiving capability information from each sensing node of a plurality of sensing nodes including the one or more sensing nodes.

Embodiment 5. The method of any of embodiments 1-4, wherein the first trigger is received from one or more of an external entity via an Application Function, AF, or an AF connected to a Network Exposure Function, NEF.

Embodiment 6. The method of any of embodiments 1-5, wherein the localization comprises one or more of positioning or tracking.

Embodiment 7. A network node, comprising a memory that stores computer-executable instructions; and a processor that executes the computer-executable instruction to perform operations, comprising: receive a first trigger to initiate sensing of a target object; facilitate performance of the sensing of the target object, resulting in sensing data; based on the sensing data, determine that localization (e.g., positioning or tracking) of the target object is to be performed; and provide to the LMF a second trigger to initiate localization of the target object.

Embodiment 8. The network node of embodiment 7, configured to perform the method of any one of embodiments 2-6.

Embodiment 9. A method performed by a Location Management Function, LMF, for initiating sensing by a Sensing Management Function, SeMF, the method comprising: receiving a first trigger to initiate localization of a target object; facilitating performance of the localization of the target object, resulting in localization data; based on one or more of the localization data or a quality of service, QoS, requirement associated with first trigger, determining that sensing of the target object is to be performed; and providing to the SeMF a second trigger to initiate sensing of the target object.

Embodiment 10. The method of embodiment 9, wherein the first trigger is received from one or more of an external entity via an Application Function, AF, or an AF connected to a Network Exposure Function, NEF.

Embodiment 11. The method of any of embodiments 9-10, wherein the determining that sensing of the target object is to be performed further comprises determining that a location accuracy associated with the localization data does not satisfy the QoS requirement.

Embodiment 12. The method of any of embodiments 9-11, further comprising: providing a location estimate, based on the localization data, to the SeMF.

Embodiment 13 The method of embodiments 9-12, wherein the determining that sensing of the target object is to be performed is based on the target object being in a predefined location.

Embodiment 14. A network node, comprising a memory that stores computer-executable instructions; and a processor that executes the computer-executable instruction to perform operations, comprising: receive a first trigger to initiate localization of a target object; facilitate performance of the localization of the target object, resulting in localization data; based on one or more of the localization data or a quality of service, QoS, requirement associated with first trigger, determine that sensing of the target object is to be performed; and provide to the SeMF a second trigger to initiate sensing of the target object.

Embodiment 15. The network node of embodiment 14, configured to perform the method of any one of embodiments 10-13.

Embodiment 16. A method performed by a Sensing Management Function, SeMF, for initiating sensing of a target object, the method comprising: receiving a first trigger to initiate sensing of the target object; determining one or more sensing nodes to perform the sensing; and determining one or more sensing parameters for the one or more sensing nodes to use to perform the sensing configuring the one or more sensing nodes to perform the sensing based on the sensing parameters; receiving sensing data from the one or more sensing nodes; and performing, by the SeMF, a network operation based on the sensing data.

Embodiment 17. The method of embodiment 16, wherein the sensing data comprises one or more radio frequency or infra-red measurements characteristic of: a Timing measurement of a time between when a signal was sent and when a reflected signal was received; a radio signal strength; a phase measurement; a multipath characteristic; a power delay profile; a delay spread; Doppler spectra; a Doppler spread; a Doppler shift; a Doppler frequency; a velocity; an Angle of arrival; or an angle of departure.

Embodiment 18. The method of any of embodiments 16-17, wherein prior to determining the one or more sensing nodes and one or more sensing parameters, the method further comprises receiving capability information from each sensing node of the plurality of sensing nodes including the one or more sensing nodes.

Embodiment 19. The method of embodiment 18, wherein the determining the one or more sensing nodes to perform the sensing is based on one or more of: proximities of the one or more sensing nodes to the target object; the capability information of the one or more sensing nodes.

Embodiment 20. The method of embodiment 19, wherein the capability information comprises monostatic, bi-static, or multi-static sensing capabilities of the one or more sensing nodes.

Embodiment 21. The method of any of embodiments 16-20, wherein the method further comprises: comparing sensing data received from each sensor node of the one or more sensor nodes; assigning a respective weight to each sensor node based on a confidence of the associated sensing data; and determining a calibrated sensing data based on the respective weights of the sensing data.

Embodiment 22. A network node, comprising a memory that stores computer-executable instructions; and a processor that executes the computer-executable instruction to perform operations, comprising: receive a first trigger to initiate sensing of the target object; determine one or more sensing nodes to perform the sensing; and determine one or more sensing parameters for the one or more sensing nodes to use to perform the sensing; configure the sensing nodes to perform the sensing; and receive sensing data from the one or more sensing nodes, wherein based on the sensing data, the SeMF performs a network operation.

Embodiment 23. The network node of embodiment 22, configured to perform the method of any one of embodiments 17-21.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a Sensing Management Function, SeMF, for initiating localization by a Location Management Function, LMF, the method comprising:
receiving, from a network node, a first trigger to initiate sensing of a target object;
facilitating performance of the sensing of the target object by a base station, resulting in sensing data;
based on the sensing data, determining that localization of the target object is to be performed; and
providing to the LMF a second trigger to initiate localization of the target object.

2. The method of claim 1, wherein the facilitating performance of the sensing of the target object further comprises:
determining one or more sensing nodes to perform the sensing; and
determining one or more sensing parameters for the one or more sensing nodes to use to perform the sensing; and
configuring the one or more sensing nodes based on the one or more sensing parameters.

3. The method of claim 2, wherein the one or more sensing parameters comprise at least one parameter related to:
sensing quality;
sensing periodicity;
sensing result structure;
sensing time;
radio frequency and/or bandwidth configuration for sensing; and
radio signal types or configuration of one or more radio signals based on which sensing is to be performed.

4. The method of claim 2, wherein prior to determining the one or more sensing nodes and one or more sensing parameters, the method further comprises receiving capability information from each sensing node of a plurality of sensing nodes including the one or more sensing nodes.

5. The method of claim 1, wherein the network node that the first trigger is received from is one or more of a Gateway Mobile Location Center, GMLC, base station, LMF or external entity via an Application Function, AF, or an AF connected to a Network Exposure Function, NEF.

6. The method of claim 1, wherein the localization comprises one or more of positioning or tracking.

7. The method of claim 1, wherein the target object is at least one of a User Equipment device, or a passive object that does not actively emit radio frequency emissions.

8. A network node implementing a Sensing Management Function, SeMF, comprising:
a memory that stores computer-executable instructions; and
a processor that executes the computer-executable instruction to perform operations, comprising:
receive, from another network node, a first trigger to initiate sensing of a target object;
facilitate performance of the sensing of the target object by a base station, resulting in sensing data;
based on the sensing data, determine that localization of the target object is to be performed; and
provide to a Location Management Function, LMF, a second trigger to initiate localization of the target object.

9. (canceled)

10. A method performed by a Location Management Function, LMF, for initiating sensing by a Sensing Management Function, SeMF, the method comprising:
receiving a first trigger to initiate localization of a target object;
facilitating performance of the localization of the target object, resulting in localization data;
based on one or more of the localization data or a quality of service, QoS, requirement associated with the first trigger, determining that sensing of the target object is to be performed; and
providing to the SeMF a second trigger to initiate sensing of the target object.

11. The method of claim 10, wherein the first trigger is received from one or more of a Gateway Mobile Location Center, GMLC, base station, SeMF or an external entity via an Application Function, AF, or an AF connected to a Network Exposure Function, NEF.

12. The method of claim 10, wherein the determining that sensing of the target object is to be performed further comprises determining that a location accuracy associated with the localization data does not satisfy the QoS requirement.

13. The method of claim 10, further comprising:
providing a location estimate, based on the localization data, to the SeMF.

14. The method of claim 10, wherein the determining that sensing of the target object is to be performed is based on the target object being in a predefined location.

15. (canceled)

16. (canceled)

17. A method performed by a Sensing Management Function, SeMF, for initiating sensing of a target object, the method comprising:
receiving, from a network node, a first trigger to initiate sensing of the target object;
determining one or more sensing nodes to perform the sensing;
determining one or more sensing parameters for the one or more sensing nodes to use to perform the sensing;
configuring the one or more sensing nodes to perform the sensing based on the sensing parameters;
receiving sensing data from the one or more sensing nodes; and
performing, by the SeMF, a network operation based on the sensing data.

18. The method of claim 17, wherein the sensing data comprises one or more radio frequency or infra-red measurements characteristic of:
a Timing measurement of a time between when a signal was sent and when a reflected signal was received;
a radio signal strength;
a phase measurement;
a multipath characteristic;
a power delay profile;
a delay spread;
Doppler spectra;
a Doppler spread;
a Doppler shift;
a Doppler frequency;
a velocity;
an Angle of arrival; or
an angle of departure.

19. The method of claim 17, wherein prior to determining the one or more sensing nodes and one or more sensing parameters, the method further comprises receiving capability information from each sensing node of the plurality of sensing nodes including the one or more sensing nodes.

20. The method of claim 19, wherein the determining the one or more sensing nodes to perform the sensing is based on one or more of:
proximities of the one or more sensing nodes to the target object;
the capability information of the one or more sensing nodes.

21. The method of claim 20, wherein the capability information comprises monostatic, bi-static, or multi-static sensing capabilities of the one or more sensing nodes.

22. The method of claim 17, wherein the method further comprises:
comparing sensing data received from each sensor node of the one or more sensor nodes;
assigning a respective weight to each sensor node based on a confidence of the associated sensing data; and
determining a calibrated sensing data based on the respective weights of the sensing data.

23. The method of claim 17, wherein the network node is one or more of a Gateway Mobile Location Center, GMLC, base station, Location Management Function, LMF, or an external entity via an Application Function, AF, or an AF connected to a Network Exposure Function, NEF.

24. (canceled)

25. (canceled)
